(19) United States
(12) Patent Application Publication
(10) Pub. No.: US 2007/0156879 A1
(43) Pub. Date: Jul. 5, 2007

(54) Considering remote end point performance to select a remote end point to use to transmit a task

(76) Inventors: Steven Edward Klein, Tucson, AZ (US); Theodore Timothy Harris JR., Tucson, AZ (US); Chung Man Fung, San Francisco, CA (US); James Chien-Chiung Chen, Tucson, AZ (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/325,071

(22) Filed: Jan. 3, 2006

(51) Int. Cl. G06F 15/173

(52) U.S. Cl. 709/223

(57) ABSTRACT

Provided are a method, system and program for considering remote end point performance to select a remote end point to use to transmit a task. A maximum outstanding tasks and a current outstanding tasks comprising a number of outstanding tasks transmitted over a network are provided. A task is received to transmit over the network. A determination is made as to whether the current outstanding tasks is less than the maximum outstanding tasks. The received task is transmitted over the network in response to determining that the current outstanding tasks is less than the maximum outstanding tasks.

### BACKGROUND OF THE INVENTION

1. Field of the Invention

The present invention relates to a method, system, and program for considering remote end point performance to select a remote end point to use to transmit a task.

2. Description of the Related Art

A local storage controller may communicate updates to a remote storage controller over a network. The paths that the local storage controller may select comprise a local port on an adapter at the local storage controller and one remote port on an adapter at the remote storage controller. The local storage controller may establish a mirror relationship with volumes at the remote storage controller so that updates to local storage are sent to the remote storage controller to apply to the remote storage. Such dual or shadow copies are typically made as the application system is writing new data to a primary storage device. International Business Machines Corporation (IBM) provides Extended Remote Copy (XRC) and Peer-to-Peer Remote Copy (PPRC) solutions for mirroring primary volumes at secondary volumes at separate sites. These systems provide a method for the continuous mirroring of data to a remote site to failover to during a failure at the primary site from which the data is being continuously mirrored. Such data mirroring systems can also provide an additional remote copy for non-recovery purposes, such as local access at a remote site. In such backup systems, data is maintained in volume pairs. A volume pair is comprised of a volume in a primary (local) storage device and a corresponding volume in a secondary (remote) storage device that includes an identical copy of the data maintained in the primary volume.

Task response time on particular paths may suffer when the bandwidth is high and the distance between the local and primary storage controller is great. In such case, the primary storage controller may be able to send a large number of outstanding tasks due to the high bandwidth, which may overburden the remote storage controller and thereby negatively impact task response times. Low bandwidth between the primary and secondary controllers may also negatively impact task response time. Further, underperformance by the secondary controller due to outdated hardware or being overburdened by tasks from multiple storage controllers may further adversely impact the task response time to the local storage controller. Delayed response times to tasks may result in tasks timing out at the local storage controller that initiated the task.

Some of the current solutions to the above problems involve increasing the bandwidth, updating the secondary storage controller hardware to handle a greater number of tasks, and limiting the number of primary storage controllers that may transmit updates or writes to the secondary storage controller.

There is a need in the art for improved techniques for improving task response time in a network environment.

### SUMMARY

Provided are a method, system and program for considering remote end point performance to select a remote end point to use to transmit a task. A maximum outstanding tasks and a current outstanding tasks comprising a number of outstanding tasks transmitted over a network are provided. A task is received to transmit over the network. A determination is made as to whether the current outstanding tasks is less than the maximum outstanding tasks. The received task is transmitted over the network in response to determining that the current outstanding tasks is less than the maximum outstanding tasks.

### BRIEF DESCRIPTION OF THE DRAWINGS

FIG. 1 illustrates an embodiment of a network computing environment.

FIG. 2 illustrates an embodiment of an adapter used in the network computing environment of FIG. 1.

FIGS. 3 and 4 illustrate an embodiment of path and port (end point) information used to select a remote port to use for a transmission.

FIG. 5 illustrates an embodiment of operations to select a remote end point to use for the task transmission.

FIG. 6 illustrates an embodiment of operations to adjust variables used to select the remote end point to use for task transmission.

### DETAILED DESCRIPTION

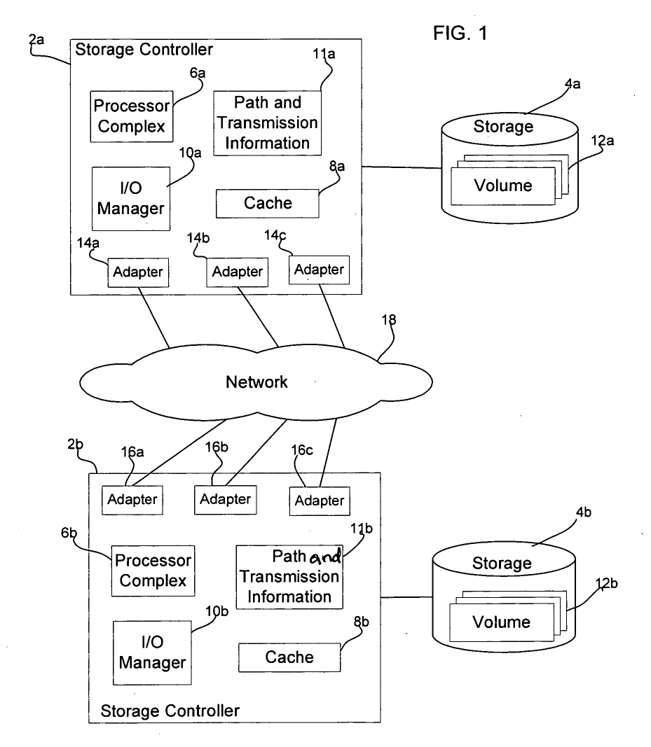

FIG. 1 illustrates an embodiment of a network computing environment. Storage controllers 2a, 2b manage access to their respective attached storages 4a, 4b. The storage controllers 2a, 2b may communicate tasks, such as I/O requests, messages and other information, to each other. The storage controllers 2a, 2b each include a processor complex 6a, 6b, a cache 8a, 8b to cache data and Input/Output (I/O) requests, an I/O manager 10a, 10b to manage the execution and transmission of I/O requests, and path transmission information 11a, 11b on tasks outstanding at remote endpoints. The storages 4a, 4b may be configured with one or more volumes 12a, 12b (e.g., Logical Unit Numbers, Logical Devices, etc.). The storage controllers 2a, 2b include one or more adapters 14a, 14b, 14c and 16a, 16b, 16c to enable communication over a network 18.

The storage controllers 2a, 2b may comprise storage controllers or servers known in the art, such as the International Business Machines (IBM) Enterprise Storage Server (ESS)® (Enterprise Storage Server is a registered trademark of IBM). Alternatively, the storage controllers may comprise a lower-end storage server as opposed to a high-end enterprise storage server. Each storage controller 2a, 2b may include multiple clusters, each cluster comprising separate processing systems on different power boundaries and implemented in separate hardware components, such as separate motherboards. The network 18 may comprise a Storage Area Network (SAN), Local Area Network (LAN), Intranet, the Internet, Wide Area Network (WAN), peer-to-peer network, etc. The storages 4a, 4b may comprise an array of storage devices, such as a Just a Bunch of Disks (JBOD), Direct Access Storage Device (DASD), Redundant Array of Independent Disks (RAID) array, virtualization device, tape storage, flash memory, etc.

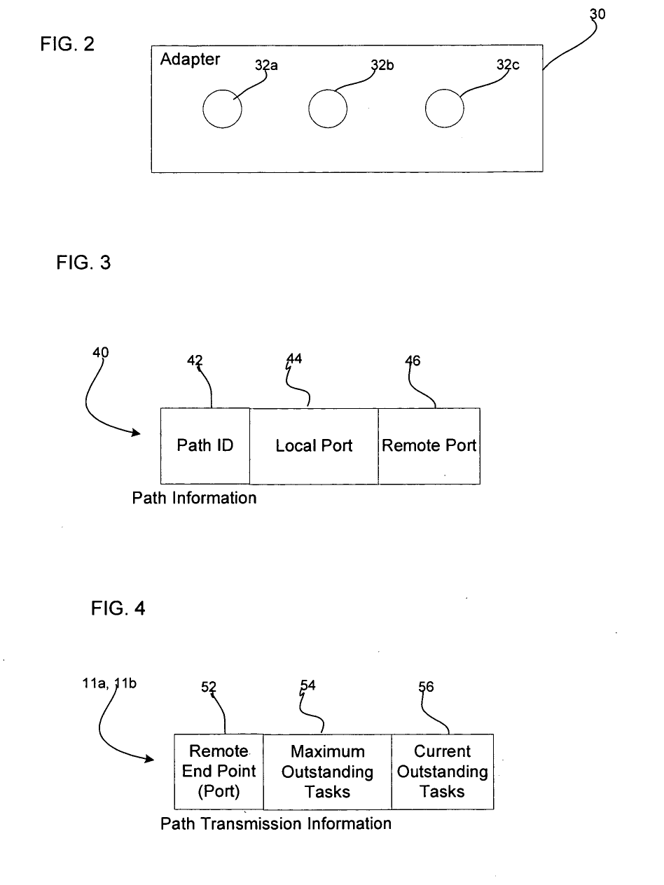

FIG. 2 illustrates an embodiment of an adapter 30, such as adapters 14a, 14b, 14c and 16a, 16b, 16c (FIG. 1). The adapter 30 may have one or more physical ports 32a, 32b, 32c, where each physical port provides a separate end point to the storage controller 2a, 2b including the adapter 30. The adapters 14a, 14b, 14c, 16a, 16b, 16c may be implemented on a motherboard of the storage controllers 2a, 2b or on an expansion card inserted in a slot of a storage controller motherboard. In certain embodiments, a path through which the storage controllers 2a, 2b communicate may comprise a port on an adapter 14a, 14b, 14c of storage controller 2a and a port on an adapter 16a, 16b, 16c of storage controller 2b. The path between storage controllers 2a, 2b may comprise a single cable or cables connected via one or more switches, where a switch enables one local port to connect to multiple ports on the remote storage controller.

FIG. 3 illustrates an embodiment of path information 40 the storage controllers 2a, 2b may maintain with the path and transmission information 11a, 11b. Path information 40 for one path includes a path identifier (ID) 40, a local port 42 on the storage controller 2a, 2b maintaining the information, and a remote port 44 on the storage controller at which the connection is made. A path comprises the local 42 and remote 44 end points. Additional path information may be maintained, such as path status, usage, etc.

FIG. 4 illustrates an embodiment of path transmission information 50 included with the path and transmission information 11a, 11b that is maintained for each end point, i.e., port 32a, 32b, 32c, on a remote storage controller adapter. The information 50 includes a remote endpoint identifier 52, i.e., port on the remote storage controller, a maximum outstanding tasks 54 comprising a maximum number of tasks that may be outstanding to that remote endpoint 52 from the local storage controller, and a current outstanding tasks 56 at the remote endpoint 52. A task may comprise an operation directed to the remote storage controller, such as an I/O request (read or write) to the storage 4a, 4b of the remote storage controller 2a, 2b, a message or other task.

A storage controller 2a, 2b may maintain the path 40 and transmission 50 information for each port on a remote storage controller with which the local storage controller communicates over the network 18.

In one embodiment, the storage controller 2a may copy updates to volumes 12a in the storage 4a to corresponding volumes 12b in the storage 4b of the remote storage controller 2b. In such embodiments, a task comprises the transmission of a write to the storage controller 2b to mirror the update to the volumes 12a.

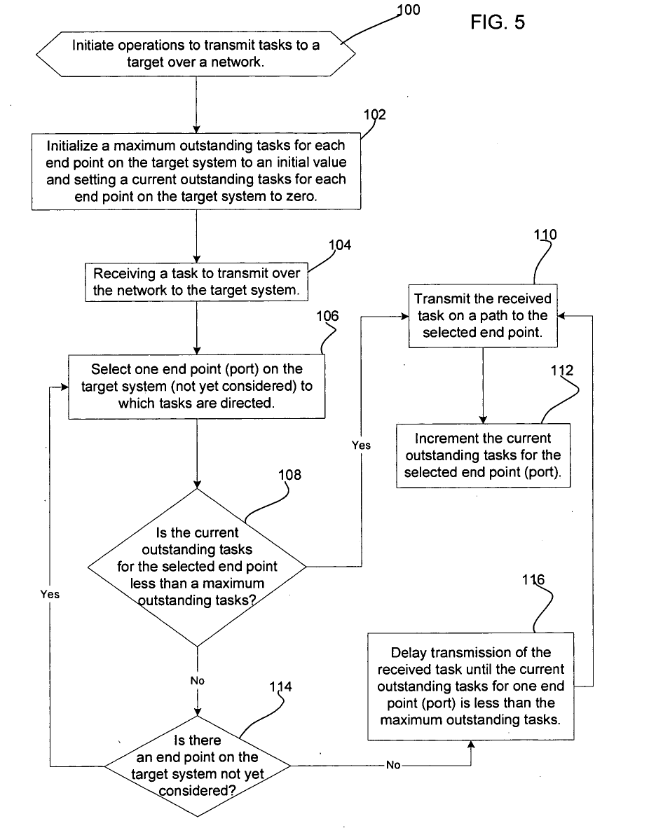

FIG. 5 illustrates an embodiment of operations performed by the I/O manager 10a, 10b to determine which remote port, i.e., end point, to use to communicate a task to the remote storage controller. Either storage controller 2a, 2b can function as the remote or local storage controller. Upon initiating (at block 100) operations to transmit tasks to a target system, e.g., remote storage controller, the I/O manager 10a, 10b initializes (at block 102) a maximum outstanding tasks 54 for each end point 52 on the target system to an initial value and sets a current outstanding tasks 56 for each end point 52 on the target system to zero. The initial value for the maximum outstanding tasks 54 may be based on empirical observation of a maximum number of tasks that may be outstanding without significantly burdening the remote target system at the end point in normal operating environments. Further, the initial value may be based on a quality of service guaranteed to the user of the local storage controller 2a, 2b.

In response to receiving (at block 104) a task to transmit over the network 18 to a target system, e.g., remote storage controller, the I/O manager 10a, 10b selects (at block 106) one end point (port) 32a, 32b, 32c on one remote adapter at the target system to which tasks are directed, where the selected end point (port) has not yet been considered for selection for the current received task. If (at block 108) the current outstanding tasks 56 for the selected end point is less than a maximum outstanding tasks 58 for the end point, then the received task is transmitted (at block 110) on a path to the selected end point. There may be multiple paths from different local ports to the selected end point port. If multiple paths to the selected end point are available (i.e., paths whose remote port 46 (FIG. 3) comprises the selected end point), then the I/O manager 10a, 10b or adapter logic may perform load balancing or some other selection method to select one of the available paths to use for transmission. The current outstanding tasks 56 for the selected end point (port) to which the task is transmitted is incremented by one.

If (at block 108) the current outstanding tasks 56 for the selected end point is not less than the maximum outstanding tasks 58 for the end point, then a determination is made (at block 114) as to whether there is another end point (port) to the target system that has not yet been considered. If there is another available end point, then control proceeds to block 106 to select and consider another port (end point). Otherwise, if there are no further remote ports on the target system to consider, then the I/O manager 10a, 10b delays (at block 116) transmission of the received task until the current outstanding tasks 56 for one end point (port) is less than the maximum outstanding tasks 54 for the end point.

In additional embodiments, if there are multiple available ports (end points) to the target system, then the I/O manager 10a, 10b may use load balancing or some other technique to select one of the available end points to use to communicate the received task to the target system.

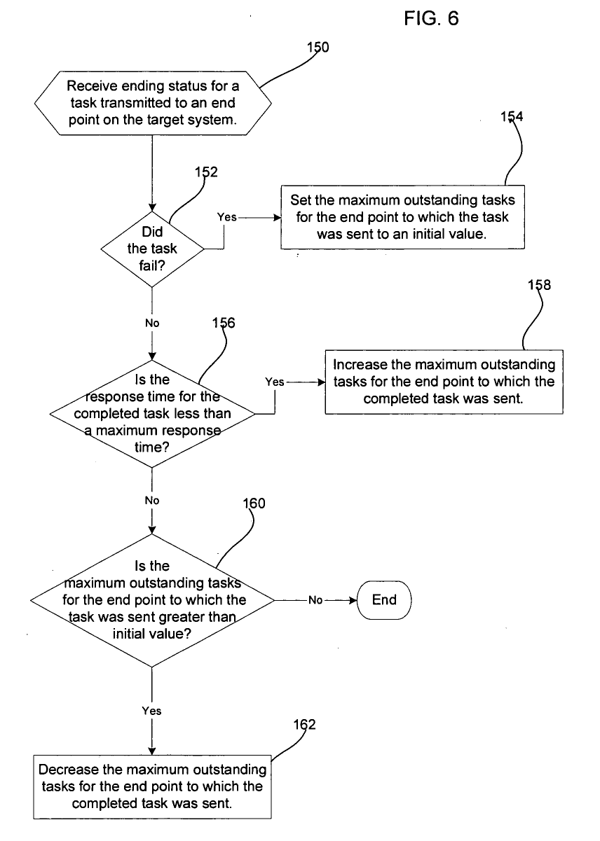

FIG. 6 illustrates an embodiment of operations performed by the I/O manager 10a, 10b to dynamically adjust the maximum outstanding tasks 54 to improve transmission performance based on the response time for tasks transmitted to the remote target system. Upon receiving (at block 150) ending status for a task transmitted to an end point 32a, 32b, 32c on the target system, if (at block 152) the task failed, then the I/O manager 10a, 10b sets (at block 154) the maximum outstanding tasks 54 for the end point to which the task was sent (and from which the status was received) to an initial or default value, such as the value to which the maximum outstanding tasks 54 was set at block 102 in FIG. 5.

If (at block 152) the task did not fail and if (at block 156) the response time for the completed task is less than a maximum response time, which may comprise an observationally determined acceptable response time commensurate with a quality of service guaranteed for users of the storage controllers 2a, 2b, then the I/O manager 10a, 10b increases (at block 158) the maximum outstanding tasks for the remote end point (port) to which the completed task was sent. This allows more tasks to be outstanding at the end point whose performance exceeds response time threshold expectations. If (at block 156) the response time for the completed task is not less than a maximum response time and if (at block 160) the maximum outstanding tasks 54 for the end point to which the task was sent is greater than the initial value, i.e., the maximum outstanding tasks 54 has been adjusted upward, then the I/O manager 10a, 10b decreases (at block 162) the maximum outstanding tasks 54 for the end point to which the completed task was sent. If (at block 160) the maximum outstanding tasks 54 for the end point to which the task was sent is not greater than the initial value, then control ends without making an adjustment downward to the maximum outstanding tasks 54 for the end point.

With the described embodiments, transmissions are not sent to a remote port if the maximum number of outstanding tasks already sent to that port by the local storage controller 2a, 2b exceeds a dynamic maximum threshold 54. This prevents tasks from continually being sent to an either underperforming remote target system or down an underperforming network path. Further, with the described embodiments, if the response time exceeds a maximum response time threshold, i.e., the response time is underperforming, then the maximum outstanding tasks threshold is decreased to reduce the load on that end point and to direct tasks to another end point that may be experiencing better performance. Moreover, if the response time performance for a completed task is better than the response time threshold, then the maximum outstanding tasks threshold may be increased to allow additional tasks to be outstanding to the over performing port (end point).

With the described embodiments, the performance of the remote end point with respect to the response time for tasks outstanding at the remote end point determines whether the particular remote end point at the target system may be selected to use for transmitting an additional task. In this way, different ports may be checked at the remote target system to determine a remote port to use for transmission that is performing at an acceptable level.

### Additional Embodiment Details

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

The operations of FIGS. 5 and 6 may be performed by a component in the storage controllers 2a, 2b other than the I/O manager 10a, 10b such as logic in the adapters 14a, 14b, 14c, 16a, 16b, 16c.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

FIGS. 3 and 4 provide an embodiment of information maintained on paths and remote ports. In alternative embodiments, the information may be maintained in different types of data structures along with additional or different information used to select paths for I/O operations.

The illustrated operations of FIGS. 5 and 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture implementing code in communication with a target system over a network, wherein the code is capable of causing operations to be performed, the operations comprising:
providing a maximum outstanding tasks;
providing a current outstanding tasks comprising a number of outstanding tasks transmitted to the target system over the network;
receiving a task to transmit over the network;
determining whether the current outstanding tasks is less than the maximum outstanding tasks; and
transmitting the received task over the network in response to determining that the current outstanding tasks is less than the maximum outstanding tasks.

2. The article of manufacture of claim 1, wherein the operations further comprise:
delaying transmission of the received task in response to determining that the current outstanding tasks is not less than the maximum outstanding tasks; and
transmitting the delayed received task in response to determining that the current outstanding tasks is less than the maximum outstanding tasks.

3. The article of manufacture of claim 1, wherein a different current outstanding tasks is maintained for each end point at a target system capable of receiving the task, and wherein the determination of whether the current outstanding tasks is less than the maximum outstanding tasks is made with respect to the current outstanding tasks for one end point at the target system.

4. The article of manufacture of claim 3, wherein the operations further comprise:
determining whether there is one additional end point at the target system not yet considered for the received task in response to determining that the current outstanding tasks is not less than the maximum outstanding tasks;
determining whether the current outstanding tasks for the additional end point is less than the maximum outstanding tasks for the additional end point in response to determining that there is one additional end point not yet considered for the received task; and
transmitting the received task over the network to the additional end point at the target system in response to determining that the current outstanding tasks for the additional end point is less than the maximum outstanding tasks for the additional end point.

5. The article of manufacture of claim 1, wherein the operations further comprise:
adjusting the maximum outstanding tasks based on a response time for one task transmitted on the network.

6. The article of manufacture of claim 5, wherein adjusting the maximum outstanding tasks based on the response time for one task transmitted on the network comprises:
determining whether the response time for one transmitted task is less than a maximum response time; and
increasing the maximum outstanding tasks in response to determining that the response time for the transmitted task is less than the maximum response time.

7. The article of manufacture of claim 6, wherein the operations further comprise:
decreasing the maximum outstanding tasks in response to determining that the response time for the transmitted task is not less than the maximum response time.

8. The article of manufacture of claim 5, wherein a different maximum outstanding tasks and current outstanding tasks are maintained for each end point at the target system to receive the task, and wherein the determination of whether the current outstanding tasks is less than the maximum outstanding tasks is made with respect to the maximum outstanding tasks and the current outstanding tasks for one path to the target system, and wherein adjusting the maximum outstanding tasks based on the response time for one task transmitted on the network comprises:
determining whether the response time for one task transmitted on one path to the target system is less than a maximum response time;
increasing the maximum outstanding tasks for the end point on which the completed task was transmitted in response to determining that the response time for the transmitted task is less than the maximum response time; and
decreasing the maximum outstanding tasks for the end point on which the completed task was transmitted in response to determining that the response time for the transmitted task is not less than the maximum response time.

9. The article of manufacture of claim 1, wherein the task comprises an Input/Output request directed to a target system.

10. A system in communication with a target system over a network, comprising:
a processor; and
a computer readable medium including code executed by the processor for performing operations, the operations comprising:
providing a maximum outstanding tasks;
providing a current outstanding tasks comprising a number of outstanding tasks transmitted over the network to the target system;
receiving a task to transmit over the network;
determining whether the current outstanding tasks is less than the maximum outstanding tasks; and
transmitting the received task over the network to the target system in response to determining that the current outstanding tasks is less than the maximum outstanding tasks.

11. The system of claim 10, wherein a different current outstanding tasks is maintained for each end point at the target system capable of receiving the task, and wherein the determination of whether the current outstanding tasks is less than the maximum outstanding tasks is made with respect to the current outstanding tasks for one end point at the target system.

12. The system of claim 10, wherein the operations further comprise:
adjusting the maximum outstanding tasks based on a response time for one task transmitted on the network.

13. The system of claim 12, wherein adjusting the maximum outstanding tasks based on the response time for one task transmitted on the network comprises:
determining whether the response time for one transmitted task is less than a maximum response time; and
increasing the maximum outstanding tasks in response to determining that the response time for the transmitted task is less than the maximum response time.

14. The system of claim 12, wherein a different maximum outstanding tasks and current outstanding tasks are maintained for each end point at the target system to receive the task, and wherein the determination of whether the current outstanding tasks is less than the maximum outstanding tasks is made with respect to the maximum outstanding tasks and the current outstanding tasks for one path to the target system, and wherein adjusting the maximum outstanding tasks based on the response time for one task transmitted on the network comprises:
determining whether the response time for one task transmitted on one path to the target system is less than a maximum response time;
increasing the maximum outstanding tasks for the end point on which the completed task was transmitted in response to determining that the response time for the transmitted task is less than the maximum response time; and
decreasing the maximum outstanding tasks for the end point on which the completed task was transmitted in response to determining that the response time for the transmitted task is not less than the maximum response time.

15. A method, comprising:
providing a maximum outstanding tasks;
providing a current outstanding tasks comprising a number of outstanding tasks transmitted over a network;
receiving a task to transmit over the network;
determining whether the current outstanding tasks is less than the maximum outstanding tasks; and
transmitting the received task over the network in response to determining that the current outstanding tasks is less than the maximum outstanding tasks.

16. The method of claim 15, wherein a different current outstanding tasks is maintained for each end point at a target system capable of receiving the task, and wherein the determination of whether the current outstanding tasks is less than the maximum outstanding tasks is made with respect to the current outstanding tasks for one end point at the target system.

17. The method of claim 15, further comprising:
adjusting the maximum outstanding tasks based on a response time for one task transmitted on the network.

18. The method of claim 17, wherein adjusting the maximum outstanding tasks based on the response time for one task transmitted on the network comprises:
determining whether the response time for one transmitted task is less than a maximum response time; and
increasing the maximum outstanding tasks in response to determining that the response time for the transmitted task is less than the maximum response time.

19. The method of claim 18, further comprising:
decreasing the maximum outstanding tasks in response to determining that the response time for the transmitted task is not less than the maximum response time.

20. The method of claim 17, wherein a different maximum outstanding tasks and current outstanding tasks are maintained for each end point at the target system to receive the task, and wherein the determination of whether the current outstanding tasks is less than the maximum outstanding tasks is made with respect to the maximum outstanding tasks and the current outstanding tasks for one path to the target system, and wherein adjusting the maximum outstanding tasks based on the response time for one task transmitted on the network comprises:
determining whether the response time for one task transmitted on one path to the target system is less than a maximum response time;
increasing the maximum outstanding tasks for the end point on which the completed task was transmitted in response to determining that the response time for the transmitted task is less than the maximum response time; and
decreasing the maximum outstanding tasks for the end point on which the completed task was transmitted in response to determining that the response time for the transmitted task is not less than the maximum response time.
